(19) United States
(12) Patent Application Publication
(10) Pub. No.: US 2024/0164415 A1
(43) Pub. Date: May 23, 2024

(54) METHOD FOR THERMALLY TREATING FOOD PRODUCTS

(71) Applicant: ATIHC S.R.L., Legnago (VR) (IT)

(72) Inventors: Marco COLTRO, Legnago (VR) (IT); Alessio SUMAN, Legnago (VR) (IT); Ivan VERZÈ, Legnago (VR) (IT)

(21) Appl. No.: 18/551,752

(22) PCT Filed: Mar. 25, 2022
(86) PCT No.: PCT/IT2022/050069

§ 371 Date: Sep. 21, 2023

(30) Foreign Application Priority Data
Mar. 25, 2021 (IT) 102021000007292

(51) Int. Cl. A23L 3/3418; A23B 7/148; A23L 5/10

(52) U.S. Cl. CPC A23L 3/3418; A23L 5/13; A23B 7/148

(57) ABSTRACT

A method for thermally treating food products is provided including arranging a treatment chamber, equipped with an opening for inserting at least one said food product, a closing element for said opening, an oxygen sensor positioned inside the treatment chamber and a passage for discharging fluids outside the chamber. The method then involves preheating the treatment chamber to an operating temperature for a treatment cycle, inserting a product inside the treatment chamber and closing the treatment chamber using the closing element. Then, the method involves starting the treatment cycle, feeding a flow of steam into the treatment chamber and detecting an initial value of the oxygen content inside the treatment chamber using the oxygen sensor.

### TECHNICAL FIELD

The present invention relates to a method for thermally treating food products.

### PRIOR ART

Apparatuses, for example ovens, for thermally treating foods, whether of vegetable, animal or bread-making origin, have long been known.

Recently, the introduction of treatment methods using steam or superheated steam, to better preserve the healthiness of the manufactured products, was taken into account by such known apparatuses.

However, the need to optimize the results of the treatment methods is widely felt, so that the health of consumers is preserved, in particular against the risks deriving from degradation and oxidation, in particular of food products during treatment. From this point of view, in particular, the treatment processes known in the art do not fully satisfy the sector of the thermal treatment of foods.

Examples of heat treatment methods for foods are illustrated in JP 2007 032889 and EP 3748237.

### SUMMARY OF THE INVENTION

The object of the present invention is solving the aforementioned problems, devising a method for thermally treating food products that allows such products to be treated optimally, in particular from the health point of view.

It is further object of the invention to provide a method for thermally treating food products that reduces treatment times, thus optimizing the use of the necessary energy resources.

The above purposes are achieved, according to the present invention, by the method and apparatus for thermally treating food products according to the present application.

According to the invention, the method for thermally treating food products provides for arranging a treatment chamber, equipped with an opening for inserting at least one food product, a closing element for said opening, an oxygen sensor positioned inside the treatment chamber, as well as a passage for discharging fluids outside the treatment chamber.

The treatment chamber is associated with a device for generating steam.

Furthermore, the treatment chamber is associated with a control unit, configured to control a steam flow as a function of an oxygen content detected by the oxygen sensor.

The method then provides for preheating the treatment chamber to an operating temperature for a given treatment cycle. The treatment chamber is preheated by heating means, for example of a known type, including the same device for generating steam.

The food product is then inserted into the treatment chamber and the closing element is positioned in the closed condition of the opening of the chamber.

It is therefore possible to start the treatment cycle, chosen for the specific product to be thermally treated, by feeding a preferably superheated flow of steam into the treatment chamber.

An initial value of the oxygen content is then detected inside the treatment chamber by the oxygen sensor.

The method then provides for progressively reducing the oxygen content inside the chamber, by dilution, i.e. by feeding in a controlled manner (that is, as a function of the detected oxygen content, through the control operated by the control unit) the steam flow inside the chamber and, correspondingly, allowing excess oxygen to flow through the aforementioned discharge passage, arranged in a condition at least partially open towards the outside of the chamber, until a detected oxygen content is equal to or lower than a maximum admissible value.

Preferably the supply of the steam flow is controlled by a control unit associated with the treatment chamber, configured so that it controls the generation of steam as a function of the detected content and, therefore, the supply of steam flow, for example with the aid of interposed valve means.

Advantageously, this reduction occurs in the shortest possible time, creating a ramp as steep as possible, representative of the reduction in oxygen content as a function of time. The method preferably provides for carrying out the step of reducing the oxygen content from an initial value, for example between 17% and 21%, to a maximum admissible value in a time interval less than or equal to 210 seconds, preferably between 10 and 210 seconds, to optimally preserve the healthiness of the treated product.

Once the admissible value for the oxygen content inside the chamber has been reached, the method according to the invention involves a maintenance step: the measured oxygen content is therefore monitored by means of the aforementioned sensor, for keeping it within the maximum admissible value, repeating, if necessary, the dilution step, using the controlled steam flow, as indicated above.

Finally, the treatment process can be interrupted after a predetermined time interval and/or upon reaching a desired treatment for the specific inserted product. In practice, the method according to the invention provides for thermally treating the food product in a controlled atmosphere, in which the oxygen content is substantially negligible.

This controlled atmosphere is therefore characterized by the presence of nitrogen and water in a gaseous physical state, i.e. water vapor, which is preferably superheated and preferably at ambient pressure.

The method according to the invention, in particular, achieves the benefits of cooking in the substantial absence of oxygen, preventing the processed food products from being oxidized, therefore degraded, generating harmful or even carcinogenic substances.

Furthermore, according to the method, the treatment, in particular the cooking, takes place under safe conditions in a cavity, the treatment chamber, which is easily sealed at a pressure which is preferably comparable to the atmospheric pressure.

The aforementioned maximum permissible value for the oxygen content is advantageously equal to or less than 1%, preferably less than 0.5%. A maximum permissible value of less than 0.25% leads to optimal treatment results.

The optimum maximum permissible value is preferably equal to 0.2%.

The fed steam is preferably superheated in advance by a superheater device associated with the treatment chamber.

The treatment method, in particular cooking, achieves the benefits of a treatment with superheated steam, rich in energy and placed directly in contact with the food product, thus reducing its fat content.

Treating in the substantial absence of oxygen, i.e. with a reduced and controlled oxygen content, in combination with a flow of superheated steam which acts directly in contact with the product allows an optimal heat exchange coefficient and thus reduces the treatment time, especially that of cooking. This heat exchange coefficient, in particular, is the effect of direct contact between the atmosphere with a reduced oxygen content created in the chamber and the product. In other words, since no containment means for the product, for example casings, is required to create a so-called “vacuum” atmosphere around the product, i.e. with a reduced oxygen content, the thermal energy of the steam flow is directly transferred to the product to be treated, thus achieving maximum benefits in terms of thermal efficiency.

In order to reduce the oxygen content in the chamber, a device for generating steam associated with the treatment chamber and, in a suitable phase relationship, said superheater device are preferably operated, so as to generate and feed the superheated steam flow at a temperature preferably between 130° C. and 600° C.

During the step of maintaining the detected oxygen content, the discharge passage is preferably closed, so as to prevent the outflow of steam from the treatment chamber, thus sealing the treatment chamber.

During the aforementioned dilution step, the vapor flow is preferably controlled so that the detection sensor registers a rate of decrease of the detected oxygen content between 0.1 and 2% O2/s, preferably between 0.15 and 2% O2/s, even more preferably between 0.2 and 2% O2/s.

It is possible to operate a ventilation assembly inside the treatment chamber, to make uniform the distribution of gases and temperatures within the treatment chamber.

The ventilation assembly inside the treatment chamber may preferably be activated after a maximum shutdown time interval equal to or less than 3 minutes from the beginning of the treatment cycle.

During the maintenance step of the detected content, valve means associated with the discharge passage can be operated to maintain the pressure inside the chamber substantially equal to a desired value, preferably equal to the atmospheric pressure.

During the aforementioned maintenance step, it is possible to reduce, that is, to choke, the flow of superheated steam inside the chamber.

During the maintenance step it is also possible to provide for the recirculation of the steam flow inside the treatment chamber, to optimize water consumption.

Preferably, the recirculating steam flow is conveyed through a superheater device, in order to superheat it.

For a product of vegetable origin, the aforementioned operating temperature is preferably between 60° C. and 130° C., preferably it is equal to 100° C. For a product of animal origin, the aforementioned operating temperature is preferably between 60° C. and 300° C., preferably between 100° C. and 250° C., preferably it is equal to 230° C.

According to the invention, a computer program is provided, including instructions which, when executed by an electronic computer, in particular the aforementioned control unit, allow the apparatus to execute the steps of the treatment method.

According to the invention, a memory that can be read by a computer, in particular by the control unit, is also provided, containing the computer program stored thereon.

### BRIEF DESCRIPTION OF DRAWINGS

The details of the invention will become more evident from the detailed description of a preferred embodiment of the method for thermally treating food products, according to the invention, illustrated by way of example in the accompanying drawings, wherein:

FIGS. 1, 2, 3 and 4 show graphs representing the effects of the treatment method on certain physical and nutritional characteristics of treated food products;

FIGS. 5, 6, 7 show diagrams representing the temperature trend in different operating conditions; and

FIGS. 8 and 9 show diagrams representing the steps of the treatment method, according to respective embodiments.

### DETAILED DESCRIPTION OF THE INVENTION

The method for thermally treating food products according to the invention provides for arranging a treatment chamber, equipped with an opening for inserting therein at least one product at a time.

Hereinafter, the use of the term “food product” refers to substances and/or preparations of substances, intended to be used as food after being thermally treated. The same term includes, for example, preferably fresh products, but also frozen or pre-cooked, bread-like products or other products of animal or vegetable origin. Examples of treatment according to the invention on both fresh and frozen meats and vegetables are illustrated below.

The treatment chamber, hereinafter referred to as the chamber, is equipped with a closing element, for example a door, for closing the insertion opening.

The chamber is also equipped with a sensor for detection of oxygen arranged inside the chamber itself, for the implementation of the method.

The sensor is advantageously arranged inside the chamber for this purpose.

The chamber further includes a discharge passage, to allow the outflow of the excess fluids, in particular excess oxygen. The discharge passage is able to put the chamber in communication with the outside in a controlled manner, for discharging the aforementioned fluids.

The chamber may further comprise a ventilation assembly.

Preferably the thermal treatment process according to the proposed method is controlled by a control unit associated with the treatment chamber, configured to correlate the control parameters, as described in detail below, in particular to manage the production of an operating fluid, the steam, depending on the oxygen content inside the chamber.

This control unit preferably provides a command interface, including for example at least one command key and/or a touch screen, for the insertion of appropriate inputs.

The method provides that the thermal treatment process, in particular the cooking, of the product takes place at a substantially zero relative pressure, therefore substantially at atmospheric pressure.

According to the invention, the treatment of the product, in particular the cooking, takes place in a substantially oxygen-free treatment environment, preferably creating an atmosphere inside the treatment chamber composed of gases, such as nitrogen and water vapor, preferably overheated.

For example, the treatment of a vegetable product can be done as follows.

A vegetable food product, in particular artichokes, weighing approximately 1 kg, preferably cleaned, washed and possibly cut, is preferably placed on a suitable support device, for example a perforated pan, commonly used for cooking vegetables.

The product, preferably with the support device, is then inserted inside the treatment chamber of a treatment apparatus, for example of the type of an oven.

Preferably, the chamber is previously heated to an operating temperature suitable for the type of product to be treated. For example, this temperature can be comprised, for a vegetable product, between 60° C. and 130° C., preferably it is substantially equal to 100° C.

It may be provided that the treatment chamber is prepared before inserting the product, with the controlled introduction of a steam flow, for example by means of a device for generating steam specifically associated with the apparatus comprising the chamber. This injection, which may precede the start of the treatment cycle to facilitate the subsequent step of reducing the oxygen content, as described below, is avoided when water and energy for the generation of steam need to be saved.

When the product is inserted into the chamber, the opening thereof is closed with the aid of the aforementioned closing element which in the example is the oven door.

The exhaust passage, on the other hand, during this step is preferably in an open condition, at least partially, therefore in communication with the chamber and with an exhaust outlet which acts as a chimney.

The treatment cycle is then started, in particular the cooking cycle, by activating a steam generator device, to introduce a flow of steam inside the chamber. Preferably the steam flow passes through a superheating device, interposed between the generator device and the chamber, to correspondingly generate a superheated steam flow to be introduced into the chamber.

This steam is preferably superheated up to a temperature in the range from 130° C. to 600° C.

The process of generating superheated steam preferably is generated rapidly, for example by correspondingly controlling the power supply to the generator device.

The ventilation assembly of the chamber can be switched on or off during the first step of generation of steam, for example by providing for a stop of the same assembly for an interval of less than 3 minutes from closing the chamber.

Meanwhile, the oxygen sensor monitors the oxygen content inside the chamber.

More precisely, the sensor records the progressive decrease of the oxygen content inside the chamber during the step of supplying steam, in particular superheated steam. This reduction is therefore achieved thanks to a subsequent dilution process, by virtue of the continuous supply of preferably superheated steam into the chamber. At the same time, a gas mixture, which is progressively less oxygen-rich and proportionally richer in water vapor, can come out through the exhaust passage in an at least partially open position.

In fact, the oxygen sensor positioned inside the chamber detects an oxygen content of the environment inside the chamber, which decreases over time with an average rate preferably in the range of (0.1÷2)% O2/s, preferably between 0.15 and 2% O2/s. Optimal results are found within the range of 0.2 and 2% O2/s. In this case, in particular, an average rate of oxygen content reduction rate of 0.135% O2/s was achieved, starting from an initial value of 20.95% O2.

The control unit of the apparatus advantageously controls the generation of steam, according to the detection of the oxygen content operated by the sensor.

When the sensor detects an oxygen content equal to or less than a maximum admissible value, the treatment process continues during a step of maintaining this value.

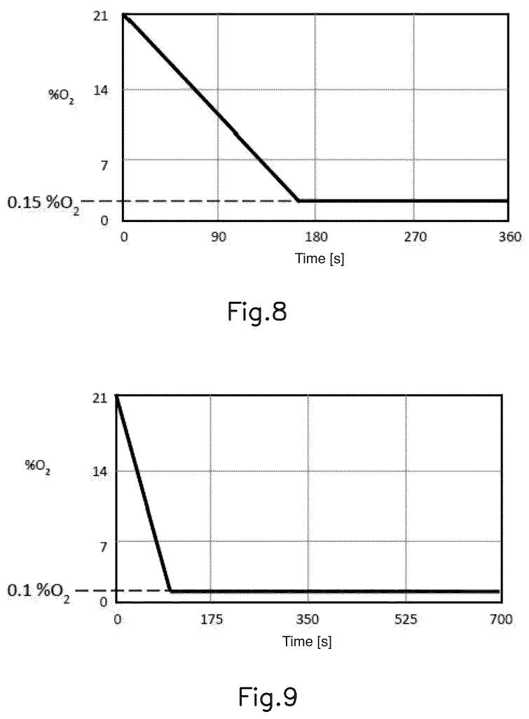

More precisely, the control unit manages the presence of oxygen inside the chamber, keeping it in the range 0÷1%, preferably in the range 0÷0.5%, even more preferably between 0 and 0.25%, during the treatment cycle, in particular during the cooking cycle, correspondingly activating the generation and feeding of the steam flow into the chamber. In the described case, for example, the maximum value is set to 0.15%, as indicated in FIG. 8.

Optimal results, in fact, are further found at the maximum admissible value of the oxygen content between 0 and 0.25%.

Preferably, during the aforementioned maintenance step, the discharge passage can be closed, so that the chamber is sealed. The sealing of the chamber, which can be advantageously operated by the control unit, has the effect of preventing the oxygen, pushed by the partial pressure difference of the same gas between the inside and the outside, from re-entering the chamber, in which, thanks to the previous step, an environment with a reduced oxygen content is created.

The process can further provide, for example, to reduce or partialize the generation of steam, to limit the use of water and energy.

For example, it is possible to provide that, during the maintenance step, the generation of steam is interrupted and that the steam flow is recirculated, preferably, through the superheating device.

More precisely, it is possible to provide that the steam passes through the chamber and returns thereto through the superheating device, by activating appropriate interposed valve means.

During the maintenance step it is possible to operate the ventilation assembly, to make the chemical composition of the gases and the temperature inside the chamber more uniform, avoiding that, due to the floating effects, the chamber is affected by a phenomenon of layering.

The treatment cycle can be interrupted after an interval of time suitable for the specific product, determined for example according to the organoleptic characteristics to be obtained.

The treatment cycle is finally interrupted and the chamber is opened to extract the treated product.

In this example of embodiment, in which one kilogram of artichokes is subjected to treatment, the treatment time is 360 seconds, according to what is illustrated in FIGS. 5 and 8, which respectively indicate the trend of the temperature and of the oxygen content in the chamber according to the treatment time, after the chamber has been closed.

After the treatment cycle has been interrupted, it is possible to weigh the treated product, pack it in a vacuum-sealed envelope or bag, subject it to a chilling cycle using a blast chiller up to a blast chilling temperature preferably equal to −36° C. and finally keep it at a storage temperature preferably equal to −18° C. The further thermal, cooling treatment avoids the degradation of the product after cooking.

Thanks to the treatment cycle described above, in particular to the steps of reducing and maintaining the oxygen content in the chamber, considerable benefits can be achieved, especially in terms of increasing the nutritional substances present in the treated product, as illustrated in the following table, in which the percentage increase indicated for each substance or parameter is indicated, with reference to a traditional treatment cycle in the presence of steam in the absence of a specific control of the oxygen content.

| | |
|---|---|
| Phenols | +19% |
| Antioxidant capacity | +41% |
| Vitamin C | +20% |
| Chlorophylls | +9% |

It is noted in particular that phenols, as is known, exert a natural antioxidant action. The presence of multiple associated phenolic groups in more or less complex structures favors the formation of polyphenols, natural substances particularly known for their positive action on human health.

The antioxidant capacity, on the other hand, is a characteristic of some nutrients, which describes their ability to slow down or prevent oxidation by free radicals.

Vitamin C, that is ascorbic acid or ascorbate, is an organic compound belonging to the group of water-soluble vitamins. This organic compound is an essential nutrient that the body is unable to synthesize in sufficient quantities and therefore it must be consumed through food. Being a highly water-soluble compound, sensitive to oxygen, heat and light, Vitamin C is a very delicate nutrient that can easily degenerate when stored and handled.

Chlorophylls, on the other hand, indicate a green pigment naturally present in plants, having high antioxidant properties that last over time. Its main action is to increase the ability of red blood cells to transport iron, thus reducing the onset of diseases, such as anemia.

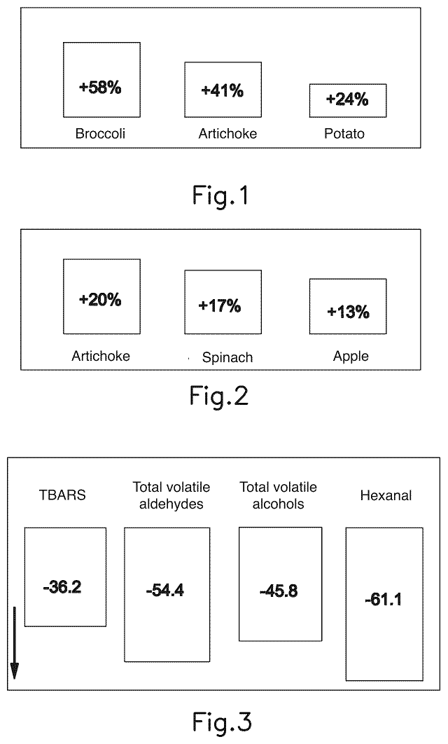

FIGS. 1 and 2, respectively, show the percentage increase in the content of antioxidants and vitamins C, for different plant products, observed thanks to the implementation of the method according to the invention, compared to traditional methods in the absence of a specific control of the oxygen content.

In particular, again with reference to FIGS. 1 and 2, for broccoli, potatoes, spinach and apple, maximum values of the oxygen content respectively equal to 0.1% O2 were set for the maintenance phase, for treatments with an operating temperature of preheating equal to 100° C. or between 60 and 130° C. In addition, with the treatment method according to the invention, in the oxygen dilution step preceding the maintenance step, an average rate of decrease between 0.1 and 0.25% O2/s was recorded, starting from an initial value of the oxygen content between 17 and 21% O2, in particular equal to 20.95% O2.

The case of a further treatment cycle, in particular cooking of a product of animal origin, i.e. adult bovine meat, according to the invention, is described below for the purpose of illustration.

The aforementioned product, weighing approximately 1 kg, is placed on a suitable support device, such as an oven grill, commonly used for cooking meat.

The product, preferably with the support device, is then inserted inside the treatment chamber of a treatment apparatus, for example of the type of an oven.

Preferably, the chamber is previously heated to an operating temperature suitable for the type of product to be treated. For example, this temperature can be, for an animal product, between 60° C. and 300° C., preferably between 100° C. and 250° C. In the present example, the operating temperature is substantially equal to 230° C.

It may be provided for preparing the treatment chamber, before inserting the product, with the controlled injection of a steam flow, for example by the device for generating steam specifically associated with the apparatus comprising the chamber. This injection, which may precede the start of the treatment cycle, favors the disposal of oxygen, as described below, but is avoided when water and energy must be saved for the generation of steam.

When the product is inserted into the chamber, the opening thereof is closed with the aid of the aforementioned closing element, for example the oven door.

The exhaust passage, on the other hand, during this step is preferably in an open condition, at least partially, therefore in communication with the chamber and with an exhaust outlet which acts as a chimney.

As in the example described above, the treatment cycle is then started, in particular the cooking cycle, by operating the device for generating steam, to introduce the steam flow inside the chamber. Preferably the steam flow passes through the superheating device, interposed between the generator device and the chamber, to correspondingly generate a superheated steam flow.

This steam is preferably superheated up to a temperature in the range from 130° C. to 600° C.

The superheated process of generation of steam is preferably generated rapidly, correspondingly powering the generator device and the superheating device.

The chamber ventilation assembly can be switched on or off during the first step of steam generation, for example by providing for a stop of the same assembly for an interval of less than 3 minutes.

Meanwhile, the oxygen sensor monitors the oxygen content inside the chamber.

The sensor records, during the step of supplying the steam, in particular superheated steam, the progressive decrease of the oxygen content inside the chamber. This reduction is obtained thanks to a subsequent dilution process, by virtue of the continuous supply of preferably superheated steam. At the same time, a gas mixture, which is progressively less oxygen-rich and proportionally richer in water vapor, can come out through the exhaust passage in an at least partially open position.

In fact, the oxygen sensor positioned inside the chamber detects an oxygen content of the environment inside the chamber which decreases over time with an average rate preferably in the range of (0.1÷2)% O2/s, preferably between 0.15 and 2% O2/s, even more preferably between 0.2 and 2% O2/s. In the present case, an average rate of decrease in oxygen content of 0.21% O2/s was recorded in the oxygen dilution step.

It is noted that the descent ramp of the oxygen content provides for a decrease rate which can vary according to the oxygen content. In particular, the average rate of decrease in the oxygen content is greater at the beginning of the procedure, for example in the range 21%-10% of oxygen content, while it can decrease at a lower oxygen content.

The control unit of the apparatus controls the generation of steam, according to the detection of the oxygen content made by the sensor.

When the sensor detects an oxygen content equal to or less than a maximum admissible value, the treatment process continues during a step of maintaining this value. More precisely, the control unit manages the presence of oxygen inside the chamber keeping it in the range 0=1%, preferably 0=0.5%, even more preferably between 0 and 0.25%, during the treatment process, in particular cooking process, by generating and feeding the steam flow in a correlated way into the chamber. In the present example, the maximum oxygen value is set to 0.1%, as indicated in FIG. 9.

Preferably, in the aforementioned maintenance step, the closure of the discharge passage can be operated, preferably by means of the control unit, in order to seal the chamber. The sealing of the chamber has the effect of preventing the oxygen, pushed by the partial pressure difference of the same gas between the internal and external environment, from re-entering the chamber, in which, thanks to the previous step, an environment with reduced content of oxygen is created.

For example, it is possible to foresee that during the maintenance step, the generation of steam is interrupted and that the steam flow is recirculated, preferably, through the superheating device.

More precisely, it is possible to provide that the steam passes through the chamber and returns thereto through the superheating device, preferably by activating appropriate interposed valve means.

During the maintenance step it is possible to operate the ventilation assembly, to make the chemical composition of the gases and the temperature inside the chamber more uniform, avoiding that, due to the floating effects, the chamber is affected by a phenomenon of layering.

The treatment cycle can be interrupted after an interval of time suitable for the specific product, determined for example according to the organoleptic characteristics to be obtained. The treatment cycle is interrupted and the chamber is opened to extract the treated product.

In the present example, the cooking cycle of adult bovine meat is interrupted after 700 s, as illustrated in FIGS. 7 and 9, which respectively show the trend of the temperature and oxygen content in the cooking chamber as a function of the treatment time, starting from the instant that the chamber is closed.

In general, the treatment cycle, in particular the cooking, of the meat can include detecting the internal temperature of the product through a preferably multi-point temperature sensor to ensure the achievement of a specific temperature value inside the product. In the present example, the temperature reached in the center of the animal product during the treatment cycle is 40° C.

After the treatment cycle has been interrupted, it is possible to weigh the treated product, pack it in a vacuum-sealed envelope or bag, subject it to a chilling cycle using a blast chiller up to a blast chilling temperature preferably equal to −36° C. and finally, keep it at a storage temperature preferably equal to −18° C. The further thermal, cooling treatment avoids the degradation of the product after cooking.

Thanks to the described treatment cycle, in particular to the steps of reducing and maintaining the oxygen content in the chamber, considerable benefits can be obtained, in particular in terms of lipid oxidation of fatty acids and cholesterol.

More precisely, the described cooking cycle allows to reduce the lipid oxidation reactions, thanks to the control of the time-temperature-oxygen content parameters, according to the invention.

In this regard, it should be noted that the degradation of nutrients present in a specific food is linked to the temperature to which the food is exposed during the treatment process, depending on the duration of the same process and the presence of oxygen in the treatment environment. The speed of the oxidation process and, therefore, of the degradation of nutrients increases with temperature and its effects are all the more burdensome the longer the treatment process is. For this reason it is important, in a treatment process, to limit the time that a food is kept at high temperatures and in the presence of oxygen.

Furthermore, it must be considered that the insertion of the products to be treated inside the treatment chamber establishes a temporary communication with the surrounding environment, which can bring the oxygen content inside the chamber, once it has been closed, to a value between 17 and 21%.

The method according to the invention provides for lowering the initial oxygen content, causing it to flow out of the treatment chamber by replacing it with a flow of preferably superheated steam. In this way it is then possible to quickly reduce, even eliminate, the oxygen initially present in the heat treatment environment, thus limiting the negative effects on food of the oxygen content in combination with high temperatures.

As regards the detection of the beneficial effects of the method according to the invention, various methods are known for measuring lipid oxidation. Certainly the most used is the test for reactive substances with thiobarbituric acid (TBARS), with which it is possible to estimate the amount of secondary products of the oxidation of fatty acids. In particular, thiobarbituric acid reacts selectively with malonaldehyde (MDA), a carbonyl compound that derives from hydroperoxides of polyunsaturated fatty acids with more than two double bonds such as, for example, linolenic acid (C18: 3 n3), EPA (C20-5 n3), DHA (C22: 6 n3) and arachidonic acid (C20: 4n6).

Volatile aldehydes are among the most important secondary products of the oxidation of fatty acids. They have a strong impact from an organoleptic point of view as they greatly affect the aroma of the products, but also have a negative effect on human health. In fact, in a “stressed” food, from the point of view of oxidative balance, such as in cooked meat, hundreds of volatile organic molecules are recognized and an important part of these are represented, in fact, by aldehydes. The advantage of this type of determination is that volatile aldehydes are not a “generic” indicator, like the TBARS test, of the oxidation of fatty acids, but they provide instead sufficiently precise indications of the fatty acid that has oxidized, and of the type of chemical, enzymatic oxidation, photo-oxidation, to which the latter has been subjected. For example, hexanal is an aldehyde generated by the oxidation process of linoleic acid.

Another important component of lipids of animal origin is cholesterol. Cholesterol is an unsaturated molecule and, as such, can oxidize in the same ways that lead to the oxidation of fatty acids. As is known, the products of cholesterol oxidation are called COPs (Cholesterol Oxidation Products) and, unlike the oxidation products of fatty acids, they are not volatile. In fact, oxidized cholesterol does not fragment into smaller compounds. This feature makes COPs more insidious than the products of oxidation of fatty acid. COPs, not being volatile, are in fact odorless and tasteless. COPs, like the volatile substances that derive from the oxidation of fatty acids, also show important negative effects on human health. The number of substances that derive from the oxidation of cholesterol, which is less than ten, is much more limited than that of the oxidation products of fatty acids. For this reason, the determination of COPs is very useful for monitoring the oxidation state of lipids. 7-ketocholesterol, for example, is the most abundant cholesterol oxidation product in food.

Thanks to the method according to the invention it is possible to obtain an average reduction of the fat content equal to 44% on the pork loin, subjecting 1 kg of this product to the treatment, preheating the chamber to the operating temperature of 230° C. and setting a content of maximum oxygen equal, for example, to 0.1% O2 during the maintenance step. In this case, in the oxygen reduction step, preceding the maintenance step, the average rate of decrease of the oxygen content, starting from an initial value of 20.95% O2, is for example equal to 0.17% O2/s.

In some cases, for example in the cooking cycles of hamburger respectively of beef and pork, for 1 kg of product, preheating the chamber to the operating temperature of 240° C. and setting, for example, a maximum oxygen content during the maintenance step equal to 0.1% O2, the reduction in fat content exceeds 90% compared to traditional steam cooking in the oven without controlling the oxygen content. In such cases, in the dilution step preceding the maintenance step, the average rate of decrease of the oxygen content, starting from an initial value of 20.95% O2, is for example equal to 0.16% O2/s.

In this regard, FIG. 3 shows the reduction of the oxidation of fatty acids resulting in a lower content of harmful/carcinogenic substances, obtained with the method according to the invention, in particular for the described treatment cycle.

The table below shows the indicators of the oxidation of fatty acids and cholesterol for the described treatment cycle, according to the invention, in comparison with those measured for a traditional steam treatment cycle, at the same internal temperature of the product of adult bovine meat, set at 40° C.

| | | Treatment process | Steam process known |
|---|---|---|---|
| | | according to the | in the art without |
| | | invention | oxygen content control |
| TBARS | mg/kg | 0.67 | 1.05 |
| Hexanal | ppm | 433.1 | 1112.7 |
| Total volatile | ppm | 722.3 | 1582.3 |
| aldehydes | | | |
| Total volatile | ppm | 477.5 | 880.5 |
| alcohols | | | |
| 7- ketocholesterol | mg/kg | 0.56 | 0.83 |
| Total COPs | mg/kg | 6.34 | 7.25 |

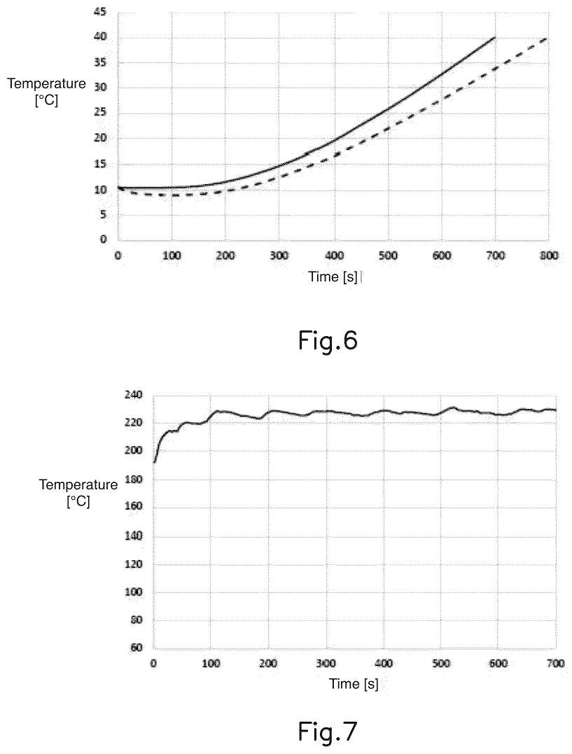

Furthermore, the method according to the invention, implemented with the use of superheated steam, has the effect of significantly reducing cooking times. In fact, the heat exchange with direct contact between the superheated steam and the product inserted inside the treatment chamber is increased by the greater energy that the superheated steam contains compared to saturated steam. The greater ability to transfer energy therefore means shorter treatment time, especially cooking time. As reported in the graph illustrated in FIG. 6, which shows the trend of the temperature inside the beef as a function of time, the temperature-time curve obtained for the method according to the invention is characterized by a greater slope, indicative of a reduced time interval, to reach the internal temperature of 40° C. The same figure, in particular, shows this trend in a continuous line, compared with the trend of the same value, in broken lines, for a traditional treatment cycle.

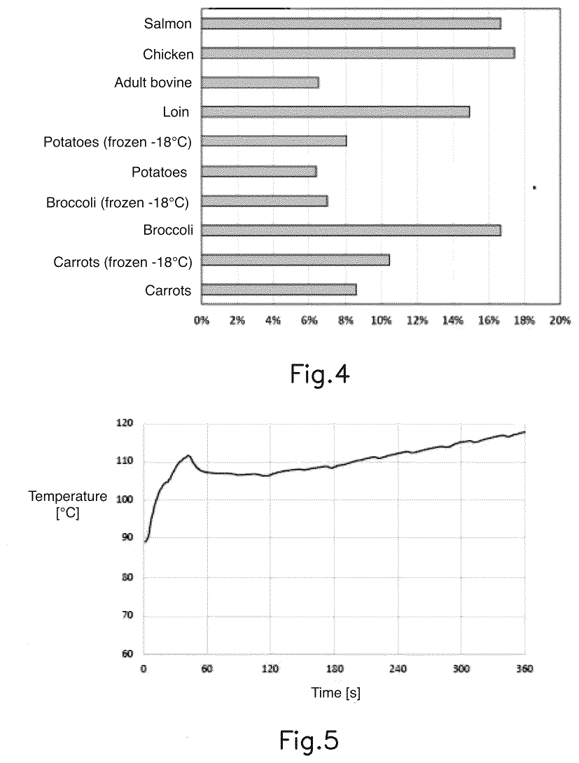

More generally, FIG. 4 shows the percentage reduction in cooking times according to the proposed method, compared to a traditional steam cooking method without oxygen content control, for different types of tested food products. For example, frozen products in quantity equal to 1 kg were treated by preheating the chamber to the operating temperature of 100° C. and maintaining the maximum oxygen value equal to 0.1% O2, starting from an initial value between 17 and 21% O2. Similar quantities by weight of salmon and chicken were treated respectively at the operating preheating temperature of 130° C. and 100° C., then maintaining a maximum oxygen value of 0.1% O2 in each case during the maintenance step, starting from an initial value between 17 and 21% O2.

It is noted in particular that the method according to the invention provides for the step of reducing the oxygen content from an initial value, for example around 21%, to a maximum admissible value, as indicated above, as quickly as possible. In practice, the method provides that, through the control unit, the generation and supply of steam into the chamber is managed, so as to dilute, that is, reduce, correspondingly, the oxygen content in the same chamber.

As shown in the aforementioned FIGS. 8 and 9, the method according to the invention therefore allows the product to be treated in an environment in which the oxygen content is controlled within a maximum admissible value of less than 1%, preferably less than 0.25%. Furthermore, the method allows the step of reducing the oxygen content from an initial value between 17 and 21% in an interval of time less than or equal to 210 seconds, preferably between 10 and 210 seconds.

The method described by way of example is subject to changes according to different needs.

In the practical embodiment of the invention, the materials used, as well as the shape and the dimensions, may be modified depending on needs.

Should the technical features mentioned in any claim be followed by reference signs, such reference signs were included strictly with the aim of enhancing the understanding of the claims and hence they shall not be deemed restrictive in any manner whatsoever on the scope of each element identified for exemplifying purposes by such reference signs.

1. A method for thermally treating food products, in particular substances and/or food preparations intended to be subjected to a thermal treatment for use as food, comprising the following steps:
a. arranging a treatment chamber, equipped with an opening for inserting at least one said food product, a closing element for said opening, an oxygen sensor positioned inside said treatment chamber and a passage for discharging fluids outside said chamber, said treatment chamber being associated with a steam generator device and with a control unit, configured to control a flow of said steam as a function of an oxygen content detected by said oxygen sensor;
b. preheating said treatment chamber to an operating temperature, chosen for a treatment cycle, by operating heating means associated with said treatment chamber;
c. inserting one said product inside said treatment chamber;
d. closing said treatment chamber by means of said closing element;
e. starting said treatment cycle, feeding a said flow of steam generated by said device for generating steam into said treatment chamber;
f. detecting an initial value of the oxygen content inside said treatment chamber by means of said oxygen sensor;
g. progressively reducing said oxygen content inside said chamber, supplying said flow of steam as a function of said oxygen content detected by the control operated by said control unit and causing excess oxygen to flow through said discharge passage, arranged in a condition at least partially open towards the outside of said chamber, until one said detected oxygen content equal to or lower than a maximum admissible value of 1% is reached;
h. maintaining said detected oxygen content within said maximum admissible value, through the control operated by said control unit, monitoring said oxygen content detected by said sensor and repeating the step g. of reducing said oxygen content, when said detected oxygen content exceeds said maximum admissible value;
i. interrupting said treatment cycle after a given time interval and/or after achieving a desired treatment for said product.

2. The method of claim 1, wherein said maximum admissible value is equal to or less than 0.5%, preferably equal to or less than 0.25%.

3. The method of claim 1, further comprising executing the step g. of reducing the oxygen content, by means of the control operated by said control unit, from an initial value between 17 and 21% in a time interval shorter or equal to 210 seconds, preferably between 10 and 210 seconds.

4. The method of claim 1, further comprising previously superheating said supplied steam by making said supplied steam pass through a superheating device associated with said treatment chamber.

5. The method of claim 4, wherein said step g. of reducing said oxygen content occurs by operating said device for generating steam associated with said treatment chamber and, in a suitable phase relationship, said superheating device, so as to generate and feed said superheated flow of steam at a temperature between 130° C. and 600° C.

6. The method of claim 4, further comprising reducing said flow of superheated steam during the step h. of maintaining said detected oxygen content.

7. The method of claim 1, wherein during said step h. of maintaining said detected oxygen content said discharge passage is closed, so as to prevent the outflow of steam from said treatment chamber, thus sealing said treatment chamber.

8. The method of claim 7, wherein during said step h. of maintaining said detected oxygen content, valve means associated with said passage are operated to maintain the pressure inside said chamber substantially equal to a desired value, preferably equal to atmospheric pressure.

9. The method of claim 1, wherein during said step g. of progressively reducing said oxygen content inside said chamber, further comprising controlling said flow of steam so that said detection sensor registers an average rate of decrease of said detected oxygen content between 0.1 and 2% O2/s, preferably between 0.15 and 2% O2/s, even more preferably between 0.2 and 2% O2/s.

10. The method of claim 1, further comprising a step of operating a ventilation assembly inside said treatment chamber, to make the distribution of gases and temperatures inside said treatment chamber uniform.

11. The method of claim 10, wherein it provides for operating said ventilation assembly inside said treatment chamber after a maximum time interval of shutdown equal to or less than 3 minutes from step e. of starting said treatment process.

12. The method of claim 1, wherein during the step h. of maintaining said detected oxygen content it provides for a recirculation of said flow of steam inside said treatment chamber.

13. The method of claim 12, wherein it provides for conveying said flow of steam in recirculation through one said superheating device, in order to superheat it.

14. The method of claim 1, wherein for a vegetable product, said operating temperature is between 60° C. and 130° C., preferably it is equal to 100° C.

15. The method of claim 1, wherein for an animal product, in particular a kind of meat, said operating temperature is between 60° C. and 300° C., preferably between 100° C. and 250° C.

16. The method of claim 1, wherein a pressure value substantially equal to the atmospheric pressure is maintained in said treatment chamber.

17. An apparatus for thermally treating food products, in particular substances and/or food preparations intended to be subjected to a heat treatment for use as food, comprising a treatment chamber, equipped with an opening for inserting at least one said food product, with a closing element for said opening, with an oxygen sensor positioned inside said treatment chamber and with a passage for discharging fluids outside said chamber, said treatment chamber being associated with a device for generating steam and with a control unit, configured to control a flow of said steam as a function of an oxygen content detected by said oxygen sensor; heating means associated with said treatment chamber; said apparatus being adapted to execute the steps of the method of claim 1.

18. A computer program comprising instructions which, when executed by an electronic computer, allow the apparatus of claim 17 to execute the steps of
b. preheating said treatment chamber to an operating temperature, chosen for a treatment cycle, by operating heating means associated with said treatment chamber;
c. inserting one said product inside said treatment chamber;
d. closing said treatment chamber by means of said closing element;
e. starting said treatment cycle, feeding a said flow of steam generated by said device for generating steam into said treatment chamber;
f. detecting an initial value of the oxygen content inside said treatment chamber by means of said oxygen sensor;
g. progressively reducing said oxygen content inside said chamber, supplying said flow of steam as a function of said oxygen content detected by the control operated by said control unit and causing excess oxygen to flow through said discharge passage, arranged in a condition at least partially open towards the outside of said chamber, until one said detected oxygen content equal to or lower than a maximum admissible value of 1% is reached;
h. maintaining said detected oxygen content within said maximum admissible value, through the control operated by said control unit, monitoring said oxygen content detected by said sensor and repeating the step g. of reducing said oxygen content, when said detected oxygen content exceeds said maximum admissible value;
i. interrupting said treatment cycle after a given time interval and/or after achieving a desired treatment for said product.

19. A computer readable memory, having stored the computer program of claim 18 thereon.
